(19) United States
(12) Patent Application Publication
(10) Pub. No.: US 2008/0170635 A1
(43) Pub. Date: Jul. 17, 2008

(54) OFDM Communication System And OFDM Receiver

(76) Inventors: Hiroshi Ochi, Fukuoka (JP); Yasushi Tsue, Fukuoka (JP); Satoru Ishii, Chiba (JP)

Correspondence Address: QUARLES & BRADY LLP, 411 E. WISCONSIN AVENUE, SUITE 2040, MILWAUKEE, WI, 53202-4497, US

(21) Appl. No.: 12/014,195

(22) Filed: Jan. 15, 2008

(30) Foreign Application Priority Data
Jan. 16, 2007 (JP) 2007-007388

(51) Int. Cl. H04L 27/28

(52) U.S. Cl. 375/260

(57) ABSTRACT

An OFDM communication system is provided that can implement more accurate signal transmission. The guard interval in the symbol section is formed by copying a predetermined number of symbols at the end portion of the symbol section and adding them to the forefront portion of the symbol portion. In the subsidiary station, the clipping start position stored in its memory is referred. Then, a predetermined number of symbols are clipped from the clipping start position. The clipped signal includes the guard interval of the symbols. However, since the guard interval is the signal obtained by copying the rear portion of the symbol, the clipping signal is the signal in which the phase of the symbol is merely deviated. An accurate symbol is obtained by performing phase correction. Thus, the influence due to multipath is suppressed while the signal transmitted from the base station can be accurately decoded.

### CROSS REFERENCE TO RELATED APPLICATION

This application claims the priority benefit of Japanese Patent Application No. 2007-007388 filed on Jan. 16, 2007.

### STATEMENT REGARDING FEDERALLY SPONSORED RESEARCH

Not Applicable.

### BACKGROUND OF THE INVENTION

1. Field of the Invention

The present invention relates to an OFDM communication system that carries out communications according to the OFDM (Orthogonal Frequency Division Multiplexing) scheme and an OFDM receiver suitable for the OFDM communication system.

2. Description of the Related Art

Conventionally, the OFDM scheme, which is a sort of multicarrier communication scheme, has been used to perform high-speed signal transmission in radio LAN (Local Area Network), ground digital broadcast and the like. Example of such a scheme is found in Japanese Patent Publication No. 2005-191662. In the OFDM scheme, a guard interval is inserted between symbols to alleviate the influence due to a multipath. This allows the influence of the multipath to be relieved to some extent. However, when the delay time of waves delayed due to the multipath becomes longer than the guard interval length, it is impossible to alleviate the influence of the multipath.

FIG. 6 is the diagram illustrating a conventional OFDM communication system. Referring to FIG. 6, three base stations 601 to 603, which are deployed at predetermined intervals, are inter-linked through the signal cable 607. The base stations 601 to 603 operate synchronously to each other and transmit the same signals with the same timing. The base stations 601 to 603 have predetermined communication areas, respectively, and use different frequencies f1, f2 and f3 for communication to avoid mutual interference, respectively. A subsidiary station 604 selects the frequency f1, f2 or f3 through the scanning operation to carry out communications at the corresponding frequency. When the subsidiary station 604 is located in the communication area 606 of the base station 603, the subsidiary station 604 (represented with 604b) performs OFDM communication with the base station 603 at the frequency f3. When the subsidiary station 604 moves from the communication area 606 of the base station 603 to the communication area 605 of the base station 601, or becomes a hand-off mode, the subsidiary station 604 (represented with 604a) scans the communication frequencies and thus performs OFDM communication with the base station 601 at the frequency f1, used by the base station 601.

In this manner, the subsidiary station 604, which is in the communication area of any one of the base station 601 to 603, is handed off between the communication areas of the base stations 601 to 603 and can communicate with the base station 601, 602, or 603 in the communication area using any one of the frequencies f1 to f3.

In the conventional OFDM system, as shown in FIG. 7, the packet signal transmitted from the base station includes a guard interval (GI) 701. A predetermined number of symbols in the rear portion of the symbol portion 702, that is, effective symbols in the OFDM (SC-OFDM) using the frequency domain equalization technique are copied and the copied portion is added as a guard interval (G1) 701 to the forefront portion of the symbol portion. In the subsidiary station 604, when the signal received from the base station is decoded, all the guard interval 701 in the forefront portion of a single symbol 702, which vanishes multipath, are removed. In the next symbol, all guard intervals 703 are removed.

In this manner, even if the interference due to the multipath as shown in FIG. 7(b) occurs to the original signal shown in FIG. 7(a), the interference to the symbol portion 702 due to the multipath in the previous symbol portion can be removed and only the information regarding the symbol portion 702 can be extracted. However, the clip timing of the above described symbol is extracted by determining the clip timing based on the information on the symbol length included in the preamble portion and the unique word portion (UW) through repeating “1010101” in the packet signal at the time the subsidiary station 604 begins receiving. The clip timing may fluctuate back and forth due to the multipath. Back or forth variation of the timing depends on the multipath environment.

If a delay due to deviation of symbol clip timing occurs as shown in FIG. 7(c), the position to be recognized for the corresponding symbol will draw behind. In such a case, the problem is that the delay of the corresponding symbol causes an interference between the corresponding symbol and the next guard interval 703, that is, an interference occurs in the corresponding symbol 702.

In the OFDM communication system shown in FIG. 6, the subsidiary station 604 may miss any one of the base stations 601 to 603 to be next received in the hand-off mode. This requires the beginning of scanning all the frequencies f1 to f3. The beginning of the scanning takes the time period for which the hand-off mode is completed, thus leading to a very inefficient operation. This leads to widening the range for radio communication. That is, an increasing number of base stations to be deployed results in an increased number of frequencies. As a result, the number of frequencies to be scanned is increased. Because the time period for which the operation retains a frequency is constant, the whole scanning time becomes longer considerably. Therefore, the problem is that the communication response becomes slow.

Moreover, with an increase in the number of frequencies to be used, the mobile subsidiary station, which is scanning plural frequencies in a long period of time, cannot receive packets transmitted from one base station. In other words, the mobile subsidiary station cannot receive packets while receiving a different frequency. As a result, when considering probabilistically, the communication success probability decreases. In order to solve such problems, the communication traffic must be increased so that packets have to be re-transmitted for a relatively long period of time.

In addition, an increased number of frequencies increases the number of frequency channels. The number of channels to be used for radio equipment is finite. As a result, a division of frequencies between plural systems has been demanded. Broadening the radio communicable range leads to tightening the number of channels. Moreover, the widened range is operated by dividing the channels without causing mutual interference between plural systems. Such a measure leads to further tightening of the number of channels. Moreover, the problem arises that when the communication range does not fall within a finite number of channels, an introduction of the system must be restricted.

The roaming method, which uses the sophisticated modulation/demodulation diffusion technique, employed in the CDMA mobile telephones, may be considered. However, in the radio communication system, which includes base stations installed easily and at low costs, that method is not realistic because expenses for system configuration and for radio receiver development and manufacture become costly.

In order to solve such a problem, the single frequency network (SFN) that includes base stations deployed in multiple different communication areas and establishes the communication between each base station and a subsidiary station at the same frequency has been developed. Example of such a method is found in Japanese Patent Publication No. 9-252278. According to that method, the simplified configuration allows a subsidiary station, which has traveled, to be handed off and the seamless communication to be established between a base station and a subsidiary station. However, with the SFN constructed in the conventional OFDM scheme, the problem on the multipath, as previously described, occurs so that it is difficult to realize accurate signal transmission.

### SUMMARY OF THE INVENTION

An object of the present invention is to provide more accurate signal transmission in an OFDM communication system employing the OFDM scheme.

Another object of the present invention is to provide more accurate signal reception in an OFDM receiver employing the OFDM scheme.

An OFDM communication system according to the present invention comprises a transmitter for transmitting a packet signal, the packet signal including a guard interval between plural symbols consisting of information and having a predetermined length, the guard interval using part of the symbols and a receiver for clipping the symbols from the packet signal received from the transmitter and decoding the information. The receiver clips a signal of the predetermined length from the packet signal received from the transmitter at a predetermined position with respect to the center position of the guard interval acting as a reference being set as a clipping start position, and decodes information transmitted from the transmitter based on the clipping signal.

The receiver in the OFDM communication system comprises receiver means for receiving a packet signal from the transmitter, storage means for storing the clipping start position, clipping means for the signal of the predetermined length from the packet signal received by the receiver, the clipping start position stored by the storage means being set as a reference, and decoder means for decoding the information based on the signal clipped by the clipping means.

The storage means in the OFDM communication system stores the center position of the guard interval as a clipping start position. The clipping means clips a signal of a predetermined length at a clipping start position being the center position of each guard interval.

The receiver in the OFDM communication system includes a frequency domain equalizer for equalizing signals from the clipping means in a frequency region; and the decoder decodes the information based on the signal from the frequency domain equalizer.

According to the OFDM communication system of the present invention, plural transmitters may be provided, each of the plural transmitters radio-transmitting the same packet signal using the same frequency and with the same timing. The receiver receives the packet signal from the transmitter located in a transmission area of the plural transmitters and then decodes the information.

According to another aspect of the present invention, an OFDM receiver is provided. The OFDM receiver receives a packet signal which includes a guard interval between plural symbols consisting of information and having a predetermined length using part of the symbols, clips each of the symbols from the packet signal, and decodes the information. The signal of the predetermined length is clipped from the packet signal at a predetermined position with respect to the center position of each guard interval, the predetermined position being set as a clip starting position, and the received signal is decoded based on the clipping signal.

The OFDM receiver further comprises receiver means for receiving the packet signal, storage means for storing said clipping start position, a clipper for clipping the signal of a predetermined length from the packet signal received by the receiver means with respect to a clipping start signal, as a reference, stored by the storage means, and a decoder for decoding the information based on the signal clipped by the clipper.

The storage means in the OFDM receiver stores the center position of the guard interval as a clip starting position. The clipper clips a signal of a predetermined length, the center position of the guard interval being set as a clip staring position.

The OFDM receiver further comprises a frequency domain equalizer for equalizing the signal from the clipper in a frequency domain and the decoder decodes the information based on the signal from the frequency domain equalizer.

According to the present invention, the OFDM communication system can perform more accurate signal transmission, and the OFDM receiver is suitable for the OFDM communication system and can perform more accurate signal reception.

### BRIEF DESCRIPTION OF THE DRAWINGS

FIG. 1 is a diagram schematically illustrating an OFDM communication system according to an embodiment of the present invention;

FIG. 2 is a block diagram schematically illustrating a base station used in the OFDM communication system according to an embodiment of the present invention;

FIG. 3 is a block diagram schematically illustrating a subsidiary station used in the OFDM communication system according to an embodiment of the present invention;

FIG. 4 shows a format for a packet signal used in the OFDM communication system according to an embodiment of the present invention;

FIG. 5 is an explanatory diagram schematically illustrating operation of the OFDM communication system according to an embodiment of the present invention;

FIG. 6 is a diagram schematically illustrating a conventional OFDM communication system; and

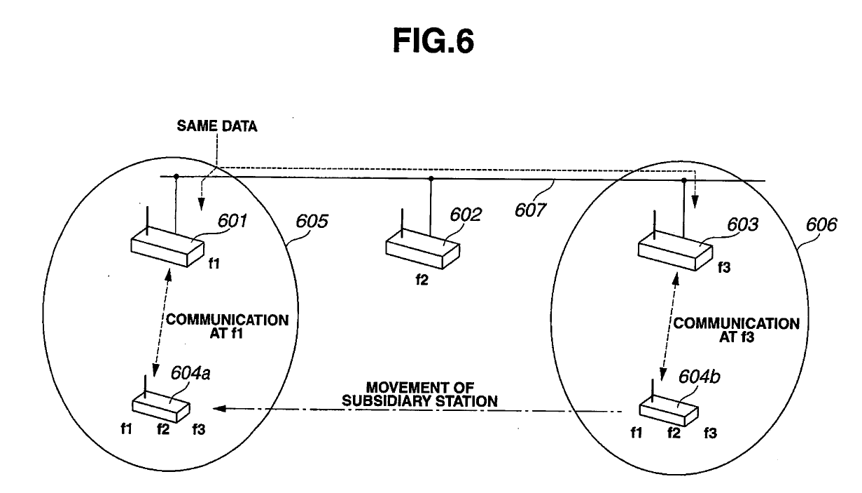

FIG. 7 is an explanatory diagram showing operation of a conventional OFDM communication system.

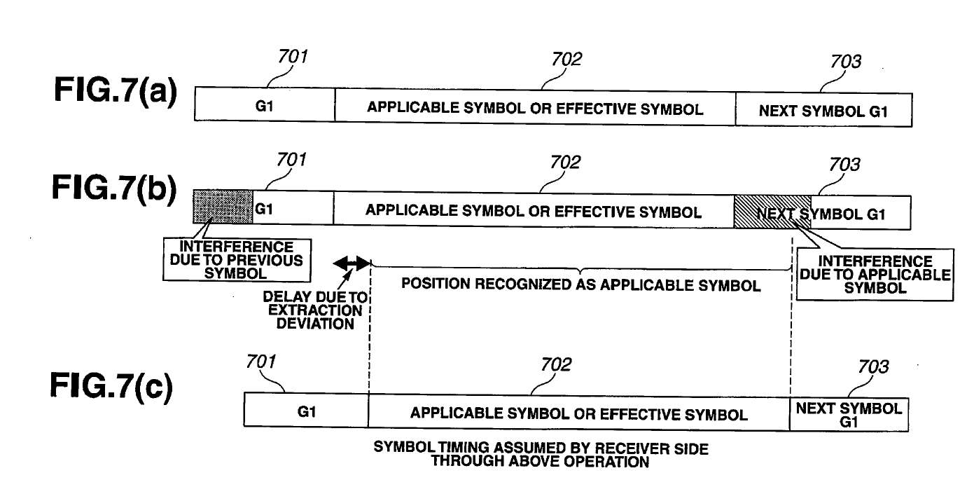

### DETAILED DESCRIPTION OF THE INVENTION

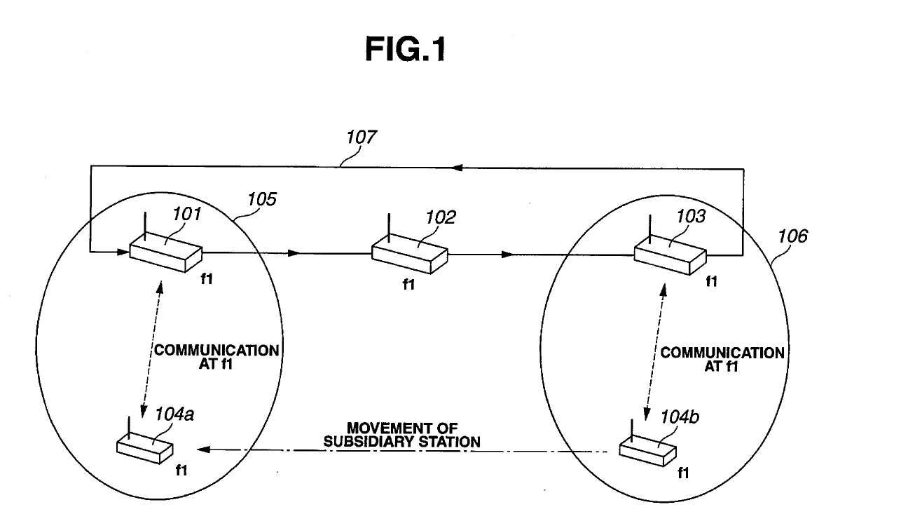

FIG. 1 is a diagram schematically illustrating an OFDM communication system according to the present invention. An example of a single frequency network (SFN) is shown, which establishes the communication between a base station and a subsidiary station at the same frequency. FIG. 1 shows an example of the OFDM (SC-OFDM) employing the frequency domain equalization technique as an OFDM communication scheme.

In FIG. 1, it is assumed that plural base stations, namely, three base stations 101 to 103 in the present embodiment are deployed. Each of the base stations 101 to 103 configures a transmitter. The subsidiary station 104 configures a receiver or an OFDM communication receiver.

For synchronization, the base stations 101 to 103 are loop linked together with the communication cable 107. The base stations 101 to 103 are synchronized and each base station transmits the same signal to the subsidiary station 104 at the same frequency and with the same timing.

In the synchronizing method over the communication cable on which transmission information, for example, is multiplexed to reference frequency clock information, the oscillation frequency of the reference frequency generator in each of the base stations 101 to 103 is accurately synchronized with the reference frequency clock information. Since the transmission information is multiplexed to the clock information, each of the base stations 101 to 103 surely generates transmission triggers with the same timing.

Using the transmission trigger, each of the base stations 101 to 103, adjusts the transmission time finely with its own delay correction parameter. In such a configuration, it appears as if the mobile subsidiary station 104, which receives signals, namely simultaneous delivery radio signals, transmitted from each of the base stations 101 to 103, receives the signal transmitted one base station with a delay dispersion due to the multipath.

For example, when the subsidiary station 104 represented by 104b is located in the communication area 106 of the base station 103, the subsidiary station 104b establishes SC-OFDM communication to the base station 101 at the frequency f1. When the subsidiary station 104 travels within the communication area 105 of the base station 101, SC-OFDM communication is carried out at the frequency f1. This allows a seamless hand-off to be realized using a single frequency.

By realizing the above operation and applying the frequency domain equalization technique to the receiving circuit of the subsidiary station 104, the simultaneous delivery radio signal can be decoded without any trouble. The originally raised problem on a large number of base stations deployed and disposed over a wide area can be solved as described above.

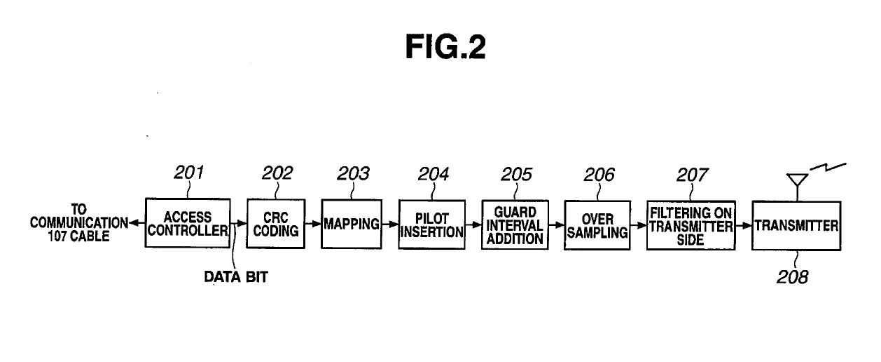

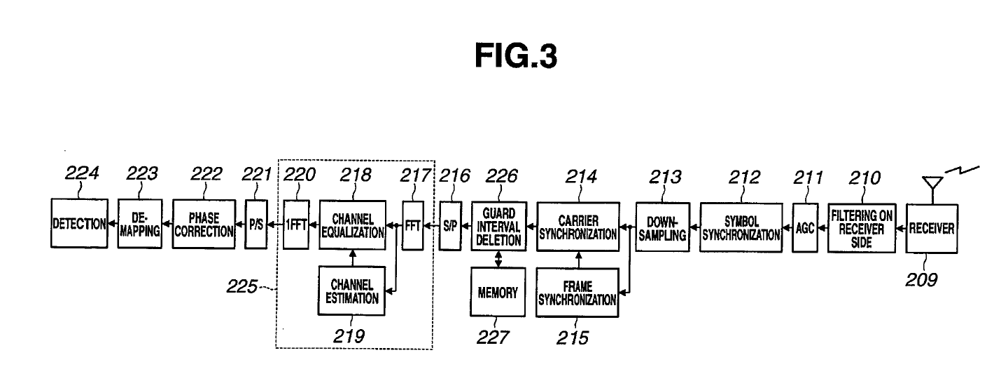

Each of FIGS. 2 and 3 is a block diagram illustrating an OFDM communication system using the frequency domain equalization according to the present invention. FIG. 2 is a block diagram illustrating a base station, namely OFDM transmitter used in the OFDM communication system. FIG. 3 is a block diagram illustrating a subsidiary station, namely OFDM receiver used in the OFDM communication system. Since each of the base stations 101 to 103, shown in FIG. 1, has the same configuration, the base station 101 is shown as a typical example in FIG. 2.

Referring to FIG. 2, the base station 101 includes an access controller 201 connected to the communication cable 107, for establishing the synchronization with other base stations 102 and 103, an encoder 202 for CRC (Cyclic Redundancy Check) encoding data bits forming information, a mapping section 203 for mapping signals encoded by the encoder 202, for example, performing symbol-to-symbol mapping, a pilot insertion section 204 for inserting a phase correction pilot signal to the signal from the mapping section 203, a guard interval adder 205 for adding guard intervals respectively to plural symbols included in the signals from the pilot insertion section 204, and an over sampling section 206 for over sampling and outputting the signal from the guard interval adder 205.

The base station 101 also includes a filtering section 207 on the transmitter side for filtering signals from the over sampling section 206 to pass a necessary signal of the signals from the over sampling section 206 and creating and outputting a packet signal or an OFDM signal, and a transmitter 208 for outputting the packet signal from the filtering section 207 as a packet signal of the frequency f1.

Referring to FIG. 3, the subsidiary station 104 includes a receiver section 209 for receiving and outputting the packet signals of the frequency f1 from the base stations 101 to 103, a filtering section 210 passing and outputting only the necessary signal of signals from the receiver section 209, an AGC (Automatic Gain control) 211 for controlling the signal level at a constant value, a symbol synchronizer 212 for symbol synchronizing the signal from the AGC 211, and down-sampling section 213 for down-sampling the signal from the symbol synchronizer.

The subsidiary station 104 also includes a frame synchronizer 215, a carrier synchronizer for carrier synchronizing and outputting the signal from the down sampling section 213 based on the signal from the frame synchronizer 215, a memory 227 for storing the clip starting position of a signal, a guard interval deletion section 226 for referring to the clip starting position stored in the memory 227 and clipping and outputting a signal of a predetermined length from the output signals of the carrier synchronizer 214, a serial/parallel (S/P) converter 216 for converting a serial signal from the guard interval remover 226 into a parallel signal, a frequency domain equalizer 225 for performing frequency domain equalization to the signal from the serial/parallel converter 216, a serial/parallel (P/S) converter 221 for converting the parallel signal from the frequency domain equalizer 225 into a serial signal, a phase compensator or corrector 222 for correcting and aligning the phase of a serial signal from the serial/parallel converter 221, de-mapping section 223 for de-mapping the signal from the phase compensator 222, for example, symbol-to-symbol de-mapping, and a detector 224 for detecting the signal from the de-mapping section 223, namely, the signal matching the information from a base station.

The clip starting position is set by an operation means (not shown) and then is stored in the memory 227. For example, since the ingress time of multipath waves may be often delayed or quickened due to communication environments, the operation means sets the clip starting position in consideration of such environments. However, the content of clipping position designation information for designating the clipping position is set to a predetermined position with respect to the center position of a guard, such as “the position led by a predetermined number bits from the center position of a guard interval” or “the position delayed by a predetermined number of bits from the center position of a guard interval”, using parameters.

As described above, the memory 227 stores as a clip starting position a predetermined position with respect to the center position of each guard interval acting as a reference point, for example, the center position of each guard interval. Thus, the memory 227 stores the clip starting position in accordance with the communication environment.

The frequency domain equalizer 225 includes a FET (high-speed Fourier transformation) section 217 for FET (high-speed Fourier transformation) processing the signal from the serial/parallel converter 216, a channel estimation section 219 for channel estimating the signal from the FET processing section 217, a channel equalizer 218 for channel equalizing the signal from the FET processing section 217 based on the channel estimation by the channel estimation section 219, and a IFET (inverse high-speed Fourier transformation) section for IFET (inverse high-speed Fourier transformation) processing the signal from the channel equalizer 220.

The receiving means is configured of a receiving section 209, a filtering section 210, an AGC section 211, a symbol synchronizing section 212, a down sampling section 213, a carrier synchronizing section 214, and a frame synchronizing section 215. The clipping means is configured of a guard interval deletion section 226. The memory 227 configures storage means for storing the clip starting position. The frequency area equalizer 225 configures frequency domain equalizing means. Decoding means is configured of a parallel/serial converter 221, a phase compensator 222, a de-mapping section 223, and a detector 224.

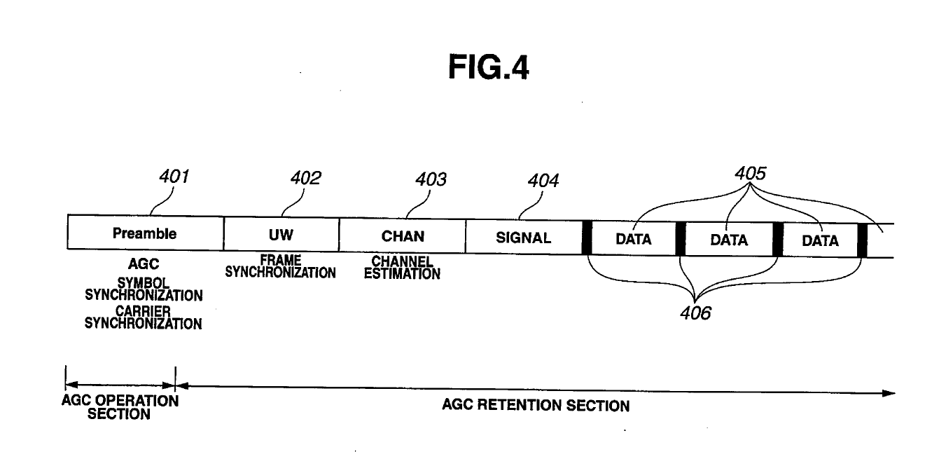

FIG. 4 is a diagram illustrating a format of a packet signal, which is created by each of the base stations 101 to 103 and transmitted to the subsidiary station 104.

Referring to FIG. 4, the packet signal includes a preamble section 401, a unique word section (UW) 402, a channel signal section (CHAN) 403, plural data section (DATA) 405, a signal section (SIGNAL) 404, plural data sections (DATA) 405, and a pilot signal section inserted between data sections 405.

The preamble section 401 is the signal section representing the starting portion of a packet signal for AGC, symbol synchronization, and carrier synchronization. The unique word section 402 is the signal section including frame synchronization information or information about a symbol length. The channel signal section 403 is the signal section including information for estimation of radio transmission path or channel, phase and amplitude. The signal section 404 is the signal section including information representing transmission rate, data amount, or the like.

Each data section 405 is the signal section including information transmitted from the base station 101 to 104 to the subsidiary station 104 or the signal section formed of a predetermined length of symbols and guard intervals. In the present embodiment, the length of the data section corresponds to 20 symbols. The last four symbols are copied every 16 symbols and are added to the forefront portion. The four symbols added to the forefront portion become a guard interval. These 20 symbols are transmitted as one block.

The above mentioned value has been shown as one example. A different number of symbols or a different guard interval length may be realized. The pilot signal section 406 inserted between data sections 405 corresponds to a pilot symbol inserted every predetermined length, namely, every 20 symbols in the present embodiment, that is, every data section 405 for carrier phase compensation.

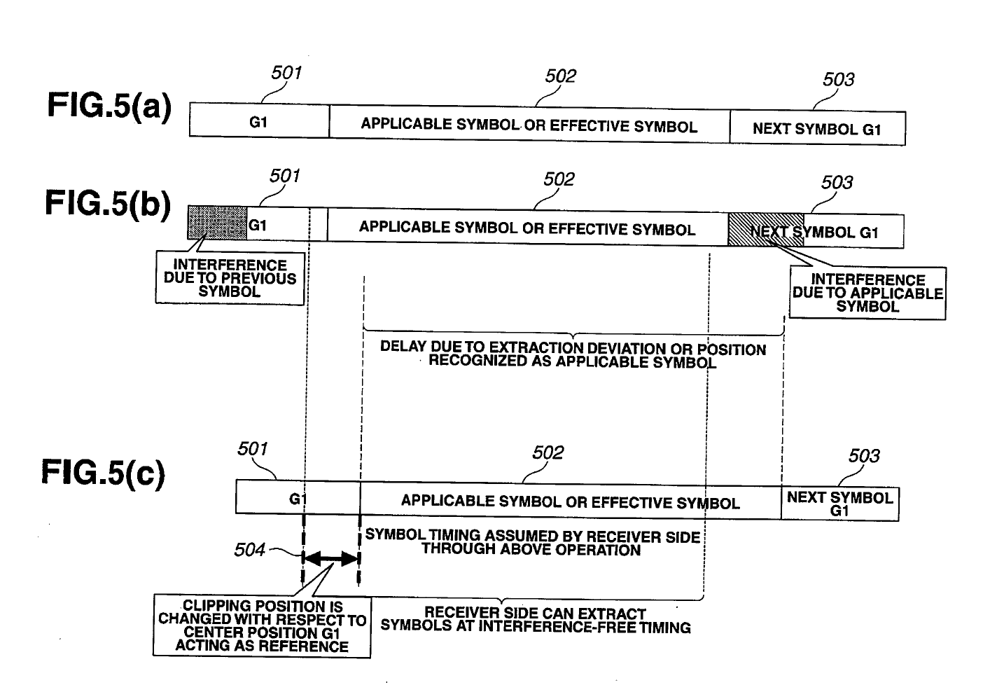

FIG. 5 is an explanatory diagram illustrating operation of an OFDM communication system according to the present embodiment. Referring to FIG. 5, the symbol section 502 represents a symbol for the multicarrier OFDM scheme or an effective symbol for SC-OFDM scheme. Numeral 501 represents a guard interval in the symbol section 502, 503 represents a guard interval in the next symbol section, and 504 represents a symbol clip starting position.

In the present embodiment, the guard intervals 501 and 503 is each formed of four symbols and the symbol section 502 is formed of 16 symbols as described above. The guard interval 501 added to the forefront section of the symbol section 502 corresponds to the symbol to which a portion of the symbol section 502, namely, the rearmost four symbols in the present embodiment, are copied and added.

In the frequency domain equalization to be described later in detail as to the operation, the channel equalization is carried out along the frequency axis using FET. In each data section 405 shown in FIG. 4, the last four symbols are copied every 16 symbols and added to the forefront portion so that the resultant structure is handled as four symbol guard interval. For that reason, when the transmission rate is 1M symbols/second, the guard interval is 4μ seconds. Even when radio waves and multipaths propagated from plural base stations have the above-mentioned delay dispersion amount, the frequency domain equalization can be realized.

The operations of the OFDM communication system and OFDM receiver described above will be explained below.

As described with reference to FIG. 1, the base stations 101 to 104 which are synchronously operated transmit the same signal to the subsidiary station 104 at the same frequency and with the same timing.

The subsidiary station 104 communicates with one of the base stations 101 to 103 in the communication area, in which the subsidiary station 104 is located, of the base stations 101 to 103. The example will be explained below where the subsidiary station 104 is located in the communication area 105 of the base station 101 and communicates with the base station. However, when the subsidiary station 104 is located in another communication area, the same communication is established with the base station, which controls the corresponding communication area.

In the base station 101 shown in FIG. 2, the encoder 202 CRC encodes data bits, which constructs information to be transmitted to the subsidiary station 104. The mapping section 203 maps the signal encoded by the encoder 104. The pilot insertion section 204 inserts the pilot signal section (refer to FIG. 4) for phase compensation between data sections 405 of the signal from the mapping section 203.

The guard interval addition section or adder 205 adds and outputs the guard interval in the previously described format to the respective symbols included in the signal from the pilot insertion section 204.

The over sampling section 206 over-samples and outputs the signal from the guard interval adder 205. The filtering section 207 filters the signal from the over sampling section 206 and thus passes necessary signals of the signals from the over sampling section 206 and creates and outputs the packet signal or SC-OFDM signal. The transmitter section 208 outputs the packet signal from the filtering section 207, as a packet signal of the frequency f1, to the subsidiary station 104.

In the subsidiary station 104 shown in FIG. 3, the receiver section 209 wirelessly receives the packet signal of the frequency f1 from the base station 101 and outputs an encoded packet signal. The filtering section 210 passes and outputs only the necessary signal of the signals from the receiver section 209. The AGC section 211 controls such that the signal level from the filtering section becomes constant. The symbol synchronizing section or synchronizer 212 symbol-synchronizes the signal from the AGC section 211. The down sampling section 213 down-samples the signal from the symbol synchronizer 212.

The frame synchronizer 215 refers to the frame synchronous information described in the unique word section 402 of the packet signal from the down sampling section 21 to perform frame synchronization. The carrier synchronizer 214 performs carry synchronization based on the frame synchronization, thus outputting the signal to the guard interval delete section 226.

The guard interval deletion section 226 refers to the clip starting position stored in the memory 227, clips the signal of a predetermined length from the signals sent by the carrier signal synchronizer 214, with the clip starting position acting as a reference, and discards the remaining signals. For example, the guard interval deletion section 226 discards the number of symbols, namely four symbols, corresponding to the guard interval from the signal of a predetermined length of 16 symbols.

The serial/parallel converter 216 converts a serial signal into a parallel signal as one FET block corresponding to 16 symbols of the signal from the guard interval deletion section 226.

This operation will be explained below by referring to FIG. 5. As shown in FIG. 5(c), the number of symbols of a predetermined length corresponding to the symbol length is clipped, with the center position of the guard interval 501 acting as the symbol clip starting position. That is, the front edge corresponding to half of the guard interval length is removed and the rear edge corresponding to half of the guard interval length is removed. In this manner, the signal of the corresponding symbol length is clipped and extracted. Thus, even under a plural multipath environment and in the SFN scheme, the signal can be suitably applied to FET decoding of OFDM or frequency domain equalization. Moreover, as described above, equalization can be suitably implemented under various conditions by varying the clip starting position with parameters.

The corresponding clipped symbol portion includes the guard interval of the corresponding symbol. However, because the guard interval is the signal of which the rear portion of the symbol is copied and the signal corresponding to the clipped symbol is the signal of which the symbol phase is shifted, accurate symbols can be obtained by performing the phase correction. The guard interval deletion section 226 outputs the symbol to the parallel/serial converter 216 after the phase correction.

The FET section 217 performs the FET process to the signal from the serial/parallel converter 216, in which the guard interval is removed. In this case, 16-point FET, for example, is used. Thus, the signal having delay information on the time axis is converted into the signal on the frequency axis. The channel equalizer 218 performs channel equalization to the information converted on the frequency axis, based on the channel information estimated by the channel estimation section 219 based on the information in the channel signal section 403. The IFFT section 220 performs the inverse Fourier transformation to the signal from the channel equalizer 218 and then outputs the result. In this manner, the frequency domain equalizer 225 performs the frequency domain equalization to the signal from the serial/parallel converter 216 and then outputs the result.

The parallel/serial converter 221 converts the parallel signal from the IFFT section 220, in other words, from the frequency domain equalizer 225, into a serial signal. The phase compensator 222 removes the pilot signal section 406 to phase correct the signal from the parallel/serial converter 221. The de-mapping section 223 de-maps the signal from the phase compensator 222 and then outputs the signal, which is obtained by decoding the signal transmitted from the base station 101. The detector 224 detects the signal matching the information from the base station 101.

As described above, in the OFDM communication system according to the embodiment of the present invention, the clip starting position of a symbol can be varied to the center position of the guard interval or to a predetermined amount in the vicinity of the center position acting as a reference using parameters. Thus, multi paths can be removed appropriately.

That is, by removing (or varying) the front edge and the rear edge corresponding to half of a guard interval are removed, a FET block of OFDM can be extracted without being influenced due to the multipath even if the timing extracted at the preamble varies. Accordingly, when an interference due to multipath as shown in FIG. 5(b) occurs in the original signal shown in FIG. 5(a), the interference to the symbol portion 502 due to the multipath in the symbol portion is removed. As a result, only the information in the symbol portion 502 can be extracted. When the extraction timing is shifted largely as shown in FIG. 5(c), the signal corresponding to the symbol portion 502 can be clipped.

Moreover, when SNF to be transmitted simultaneously from plural base stations is formed, the possibility that the strongest wave of the multipath signal particularly is not an initial wave is strong considerably. The possibility that an extraction shift of the symbol timing occurs increases more. The present embodiment can favorably suppress an adverse effect due to multipath.

In the present embodiment, an example of the communication between a base station and a subsidiary station has been explained. However, the present embodiment can be utilized in various communication field where information communication performs unit-directionally or bi-directionally, such as radio LAN (Local Area Network), digital broadcast, data communications, and the like.

Moreover, the present embodiment has been explained with the example of SC-OFDM. However, the present embodiment can be applied to OFDM of a multicarrier. Also, the present invention can be applied to the communication between a base station and a subsidiary station or network communication, in which different frequencies are used. It is to be understood that the present invention can be utilized in various communication fields, where information communications are performed uni-directionally or bi-directionally, commencing with networks, broadcasts, data communications, which use OFDM or SC-OFDM.

While there has been shown and described what are at present considered the preferred embodiment of the invention, it will be obvious to those skilled in the art that various changes and modifications can be made therein without departing from the scope of the invention defined by the appended claims.

What is claimed is:

1. An OFDM communication system, comprising:
a transmitter for transmitting a packet signal, said packet signal including a guard interval between plural symbols consisting of information and having a predetermined length and said guard interval using part of said symbols; and
a receiver for clipping said symbols from said packet signal received from said transmitter and decoding said information;
said receiver clipping a signal of said predetermined length from said packet signal received from said transmitter at a predetermined position with respect to the center position of said guard interval acting as a reference being set as a clipping start position, and decoding information transmitted from said transmitter, based on said clipping signal.

2. The OFDM communication system as defined in claim 1, wherein said receiver comprises receiver means for receiving a packet signal from said transmitter; storage means for storing said clipping start position; means for clipping said signal of said predetermined length from said packet signal received by said receiver, the clipping start position stored by said storage means being set as a reference; and decoder means for decoding said information based on the signal clipped by said clipping means.

3. The OFDM communication system as defined in claim 2, wherein said storage means stores the center position of said guard interval as a clipping start position; and wherein said clipping means clips a signal of a predetermined length at a clipping start position being the center position of each guard interval.

4. The OFDM communication system as defined in claim 2, wherein said receiver includes a frequency domain equalizer for equalizing signals from said clipping means in a frequency region; and wherein said decoder decodes said information based on the signal from said frequency domain equalizer.

5. The OFDM communication system as defined in claim 1, wherein said OFDM communication system includes plural transmitters, each of said plural transmitters radio-transmitting the same packet signal using the same frequency and with the same timing; and wherein said receiver receives said packet signal from said transmitter located in a transmission area of said plural transmitters and then decoding said information.

6. An OFDM receiver for receiving a packet signal, said packet signal including a guard interval between plural symbols consisting of information and having a predetermined length, said guard interval using part of said symbols, clipping each of said symbols from said packet signal, and decoding said information, said signal of said predetermined length is clipped from said packet signal at a predetermined position with respect to the center position of each guard interval, said predetermined position being set as a clip starting position, and said received signal is decoded based on said clipping signal.

7. The OFDM receiver as defined in claim 6, further comprising: receiver means for receiving said packet signal; storage means for storing said clipping start position; a clipper for clipping said signal of a predetermined length from said packet signal received by said receiver means with respect to a clipping start signal, as a reference, stored by said storage means; and a decoder for decoding said information based on the signal clipped by said clipper.

8. The OFDM receiver as defined in claim 7, wherein said storage means stores the center position of said guard interval as a clipping start position; and wherein said clipper clips a signal of a predetermined length, the center position of said guard interval being set as a clipping start position.

9. The OFDM receiver as defined in claim 6, further comprising a frequency domain equalizer for equalizing the signal from said clipper in a frequency domain; and wherein said decoder decodes said information based on the signal from said frequency domain equalizer.
